(19) United States
(12) Patent Application Publication
(10) Pub. No.: US 2018/0011978 A1
(43) Pub. Date: Jan. 11, 2018

(54) WELLNESS TRACKING SYSTEM

(71) Applicant: Cisco Technology, Inc., San Jose, CA (US)

(72) Inventor: David Reeckmann, San Francisco, CA (US)

(21) Appl. No.: 15/203,688

(22) Filed: Jul. 6, 2016

(51) Int. Cl. G06F 19/00; G06N 5/04; G06N 99/00

(52) U.S. Cl. CPC G06F 19/345; G06N 99/005; G06F 19/3481; G06F 19/363; G06N 5/04

(57) ABSTRACT

The subject disclosure relates to systems for collecting and analyzing user data to make determinations regarding the wellness of individual users, or groups of users (e.g., user teams). A wellness tracking system of the subject disclosure may be configured to perform operations including receiving user data for a user, associating the user with a profile, and receiving a goal for the user, wherein the goal indicates one or more behavioral goals for the user. The wellness tracking system may also be configured to perform operations for providing one or more targeted recommendations to the user, wherein the targeted recommendations are based on the profile and the goal associated with the user. Methods and computer-readable media are also provided.

### BACKGROUND

The disclosed technology relates to systems and methods for tracking user activities, and in particular, for tracking user activities/behaviors to make determinations regarding the user's well-being or mental health. In some aspects, tracking can be implemented for multiple users or user teams, for example, to facilitate wellness determinations at an individual level, or for an entire team or group.

### BRIEF DESCRIPTION OF THE DRAWINGS

Certain features of the technology are set forth in the appended claims. However, the accompanying drawings, which are included to provide further understanding, illustrate disclosed aspects and together with the description serve to explain the principles of the subject technology. In the drawings:

FIG. 1 illustrates an example environment that may be used to implement a mental health tracking system (e.g., “health tracking system,” or “tracking system”), according to some aspects of the subject technology.

FIG. 2 conceptually illustrates an example of user data types, and the flow and/or processing of data that can be used to implement aspects of the technology.

FIG. 3 provides a graphical illustration of example activity levels and activity types for a user, according to some aspects of the technology.

FIG. 4A illustrates an example of a graphical user interface (GUI) that can be used to provide feedback (e.g., to a user or administrator), according to some aspects of the technology.

FIG. 4B illustrates another example of a GUI that can be used to provide user feedback, according to some aspects of the technology.

FIG. 5 illustrates an example of a GUI that may be used to provide feedback regarding the performance or well-being of a user group or team, according to some aspects of the technology.

FIG. 6 illustrates steps of an example method that can be used to implement a mental health tracking system, according to some aspects of the technology.

FIG. 7 illustrates an example of a network device.

FIGS. 8A and 8B illustrate example system embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it is clear and apparent that the subject technology is not limited to the specific details set forth herein and can be practiced without these details. In some instances, structures and components are shown in block diagram form in order to avoid obscuring the concepts of the subject technology.

### Overview

One factor implicating the performance of knowledge workers (e.g., office employees) is mental well-being. In standard office environments, data regarding employee well-being or satisfaction may be collected periodically, for example, using paper surveys provided by a human resource department. However, employee volunteered survey data is typically not of a sufficient quality or quantity to make actionable determinations regarding how to improve employee satisfaction or health. Furthermore, user data collected via survey is not typically in a format that can be readily analyzed or cross-referenced to make conclusions about the healthfulness of an office environment.

### Description

Aspects of the subject disclosure address the foregoing problems by providing systems, methods, and machine-readable media for collecting and analyzing user/employee data for the purpose of monitoring (1) well-being/mental health of a specific user; and (2) well-being/mental health of a group of users (e.g. a user team). As discussed in further detail below, mental health metrics can be used to generate actionable insights that can be used to enhance user health and satisfaction.

In one example embodiment, the technology can include a combination of hardware sensors and software applications. For example, the system may consist of hardware and software modules configured for receiving information regarding a user's daily activities, including but not limited to: physical activity levels or types, work business level (e.g., based on calendar information or workstation use), time spent at a desk, interruption frequency, meeting information (e.g. indicating when the user is in work a work meeting), break frequency and/or duration, and/or user provided survey information. Depending on implementation, the collection of user data may be performed on different time-scales. For example, user activities such as breaks or durations spent in meetings may be tracked on a day-by-day, hour-by-hour, or minute-by-minute basis, etc.

Data collection can be performed by dedicated hardware, such as one or more “beacons” configured to detect a user's presence and/or activity level. In some aspects user data collection can be performed using user wearable or user carried devices, including but not limited to: fitness trackers, mobile phones, and/or smartphone devices. As discussed in further detail below, user data collection can also be facilitated using prompts or questions that are provided to the user (e.g., via a smartphone or personal computing device), to solicit the users' input of data, for example, regarding the user's feelings of health or emotional wellness, as well as indications of the user's desired activity level, and/or emotional and physical goals.

Aggregation of collected user data can be performed using one or more software modules configured to receive user data, and to analyze user data in order to generate insights regarding the associated user's mental health and well-being. For example, software modules residing on the user's mobile device (e.g., mobile applications or “apps”), or on a personal computer can be configured to collect data indicating the user's activity/business level. Collected data is then analyzed to determine if the user is likely to be burdened by stress (for example, corresponding with a high-busyness level, and a low mental health assessment), or if the user has adequate levels of free time/rest and is taking regular work breaks, for example, corresponding with a low busyness level and a high mental health assessment.

In practice, individual users can be initially categorized using a particular profile type through association with a pre-specified set of qualities. User association with any particular profile type may occur automatically based on tracked behavioral metrics, or performed based on user feedback/input, for example, provided in response to survey questions. In some aspects, users can specify specific behavioral goals they wish to achieve. For example, a user may specify one or more of the following goals: “increase productivity” (e.g., corresponding with longer work sessions, fewer intervals, fewer meetings, and/or fewer breaks), “greater focus” (e.g., greater number of breaks, and/or less interruptions), “decreased stress” (e.g., increased break time and/or break frequency), and/or “more fun” (e.g., corresponding with more frequent distractions or interruptions). Subsequently, recommendations can be generated based on the user's specific goals, as well as the user's associated profile information. In some aspects, user provided recommendations may change as a consequence of changes in the user's behavior and/or changes made to the user's profile.

It will be appreciated that analysis of the user data can be performed using computer-generated models (e.g., behavior models), for example, that may employ a self-updating or machine-learning approach (e.g., a machine learning model). By way of example, user data collected for multiple users can be used to update (i.e. “train”) a health model that can be used to infer/predict mental health aspects for any one of a variety of users, or a collection of users, such as a group of office employees.

Similar to the above aspects, the assignment of profiles and goals can also be performed for a collection of users, or a user group. By assessing the overall well-being and productivity of a team of users, a manager or administrator, such as a team-lead or human resource department, can be better equipped to assess the well-being of a group, and to make better decisions affecting the productivity and well-being of the group.

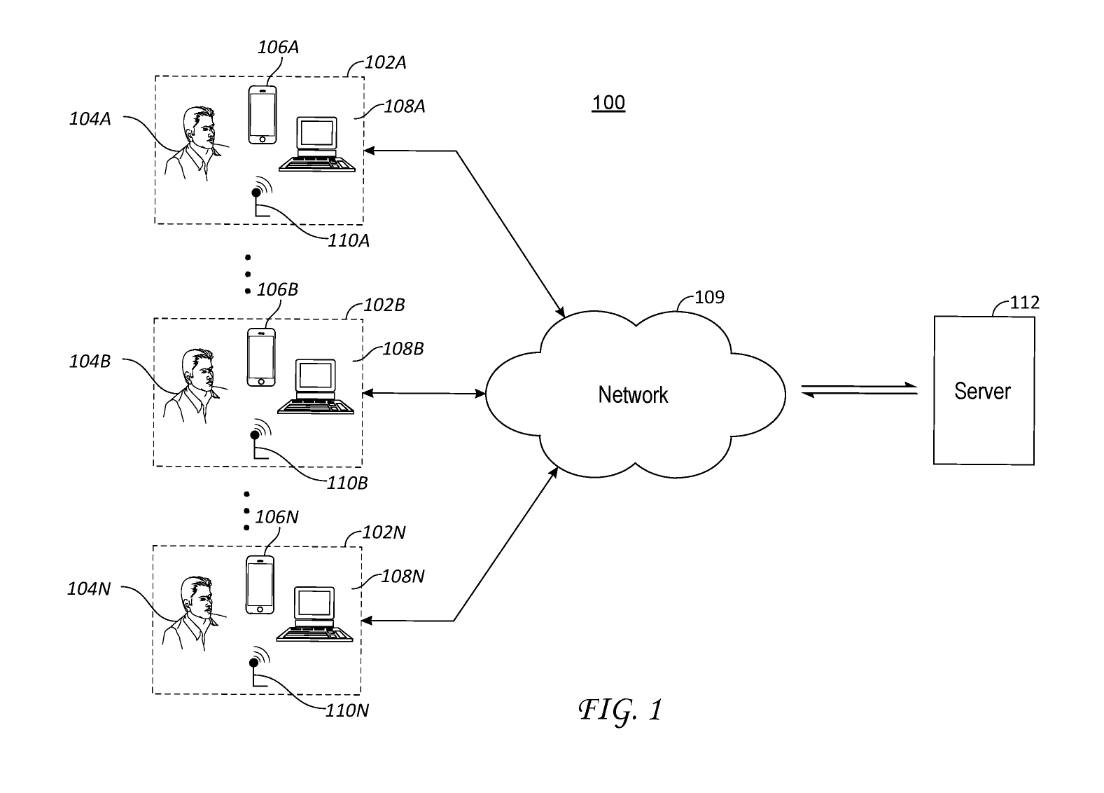

FIG. 1 illustrates an example environment 100 that can be used to implement a wellness tracking system (e.g., “a mental health tracking system”), according to some aspects of the disclosure. Environment 100 includes multiple user environments 102 (e.g., 102A-102N) that are communicatively connected to a server 112, e.g., via network 109. Environment 100 can include a greater (or fewer) number of user environments 102, without departing from the scope of the technology. It is also understood that network 109 can represent a variety of electronic communication means, including but not limited to one or more of: a wired network, a wireless network, virtual networks, and/or public/networks such as one or more wide area networks (WANs) or local area networks (LANs), and/or a network of networks, such as the Internet. Additionally, although server 112 is illustrated as a single device, it is understood that server 112 can represent multiple computing devices, such as a network of computers, a computing cluster or other various types of distributed computing environments.

Each user environment 102 includes one or more users 104 that are associated with respective mobile devices 106, computing devices 108, and/or beacons 110. For example, user environment 102A includes user 104A, which is associated with mobile device 106A, computing device 108A, and beacon 110A. Various user environments 102 can include physical and/or virtual locations that are occupied or frequented by one or more users. For example, user environment 102A represents a physical environment (such as a room, office and/or cubicle) that is used or occupied by user 104A. Additionally, user environment 102A includes virtual spaces or environments with which user 104A can interact, including mobile device 106A, and computing device 108A. It is understood that any of user environments 102 can include a greater (or fewer) number of processor-based devices that can be associated with one or more users in the corresponding environment.

As discussed in further detail below, mobile devices 106, computing devices 108, and beacons 110 can be used to collect various types of information about respective users 104 (e.g., “user information”). In some aspects, mobile devices 106 and/or computing devices 108 can be used to provide survey questions and/or information prompts, for example, to elicit user feedback about aspects relating to the user's mental and/or well-being. Similar to mobile devices 106, computing devices 108 can also collect user information, for example, regarding the user's activity level, including physical activities, and/or busyness level, such as, an amount of work or intensity of work engagement in an office environment.

By way of example, mobile devices 106, computing devices 108, and/or beacons 110 can be used to collect desk data, meeting data, and/or break data, etc. As used herein, desk data can include any information relating to a user's time spent at his/her desk, and/or relating to activities performed at the desk or in the immediate work vicinity. Meeting data can include any information relating to a user's expenditure of time in meetings, and may be received by, or pulled from, one or more electronic calendars, such as a user managed calendar executed on one of mobile devices 106 or computing devices 108. Break data can include any information relating to breaks or resting periods taken throughout a user's work day. In some aspects, break data may be inferred, for example, from empty timeslots on the user calendar, or from inferences made using one or more of: survey data, activity data, and/or desk data, etc.

Beacons 110 can be implemented as physical hardware installed at, or near, a user's work environment (e.g., in user environment 102). Beacons 110 can include a variety of hardware sensors configured to detect various aspects of user activity, including but not limited to one or more of: a user's presence/absence from user environment 102, a user's sitting/standing status, a number of times the associated user leaves or reenters user environment 102, and/or a general activity level of the associated user, etc. In some implementations, beacons 110 may include one or more infrared (IR), sonar, or other optical sensors, for example, that can be configured to detect the presence/absence of an associated nearby user. Additionally, beacons 110 can include one or more communication modules, for example, that is configured for wired or wireless communication for providing collected user data to server 112.

As indicated in environment 100, mobile devices 106, computing devices 108, and beacons 110 can all be configured to collect user data and to transmit the user data to a server (e.g., server 112), via a network (e.g., network 109). As discussed in further detail below, collected user data can be used to determine a well-being status for a particular user, or for a group of users, such as a user team or collection of office employees.

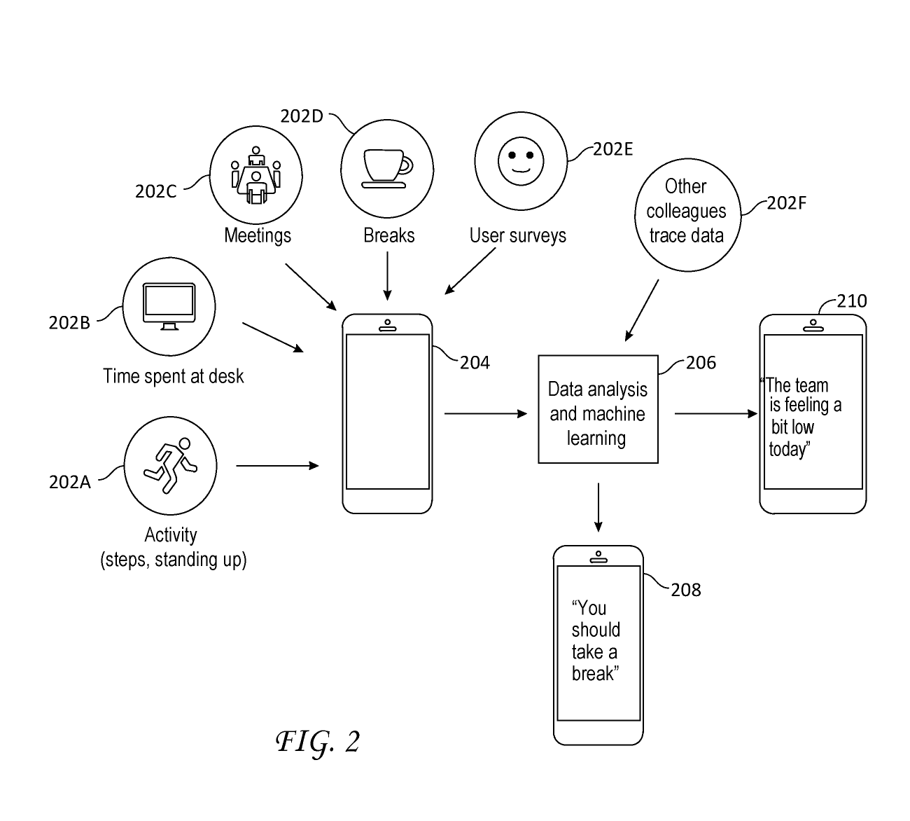

In practice, user data can be collected for each of multiple users associated with a respective user environment 102. For example, user data for user 104A, in user environment 102A, can be collected by one or more of mobile device 106A, computing device 108A, and/or beacon 110A. Collected user data can then be transmitted to server 112 (e.g., via network 109), for further processing and analysis. Depending on the well-being of user 104A, feedback, tips or other health recommendations can be provided to user 104A, or to another user, such as a human resources functionary. By way of example, if a determination is made at server 112 that user 104A is particularly stressed out or overworked, server 112 can generate recommendations for reducing stress, for example, by suggesting that the user take more frequent breaks or leave the office at an earlier time. Examples of the types of user data that can be collected, as well as examples of view of user/group feedback, are discussed in further detail with respect to FIG. 2.

In particular, FIG. 2 conceptually illustrates an example of data types that may be collected, as well as the flow and/or processing of data used to implement aspects of the technology. Various types of user data 202 can be collected by, or provided to, a mobile device associated with a particular user (e.g., mobile device 204). It is understood that various types of user data can be provided to, or collected by, various other processor-based devices associated with a particular user. Further to the example discussed above with respect to environment 100, any of the user data types depicted in FIG. 2 may be received by a personal computer, such as a laptop, notebook, or tablet computing device (e.g., one of computing devices 108).

As illustrated in the example of FIG. 2, the various types of user data 202 may include, but are not limited to one or more of the following: activity data 202A, desk data 202B, meeting data 202C, break data 202D, survey data 202E, and/or user data for one or more other users 202F. Collected data can be analyzed either locally (e.g., by mobile device 204), or remotely, for example, using one or more computers/servers, such as server 112, discussed above.

In some aspects, analysis of user data is performed in the context of a user goal and/or a user profile for the corresponding user. For example, any targeted recommendations generated for and provided to a user can be based on one or more user indicated goals, and/or a profile associated with the user. Additionally, processing or analysis of user data can be performed using a machine learning approach 206. As discussed in further detail below, the analysis of user data can result in the generation and transmission of recommendations to the user, or to a group of users. In the example of FIG. 2, data analysis and machine learning step 206 results in a user recommendation provided to a user's smartphone device (208), or provided to a group of users or team leader/office manager, for example, displayed on smartphone device 210.

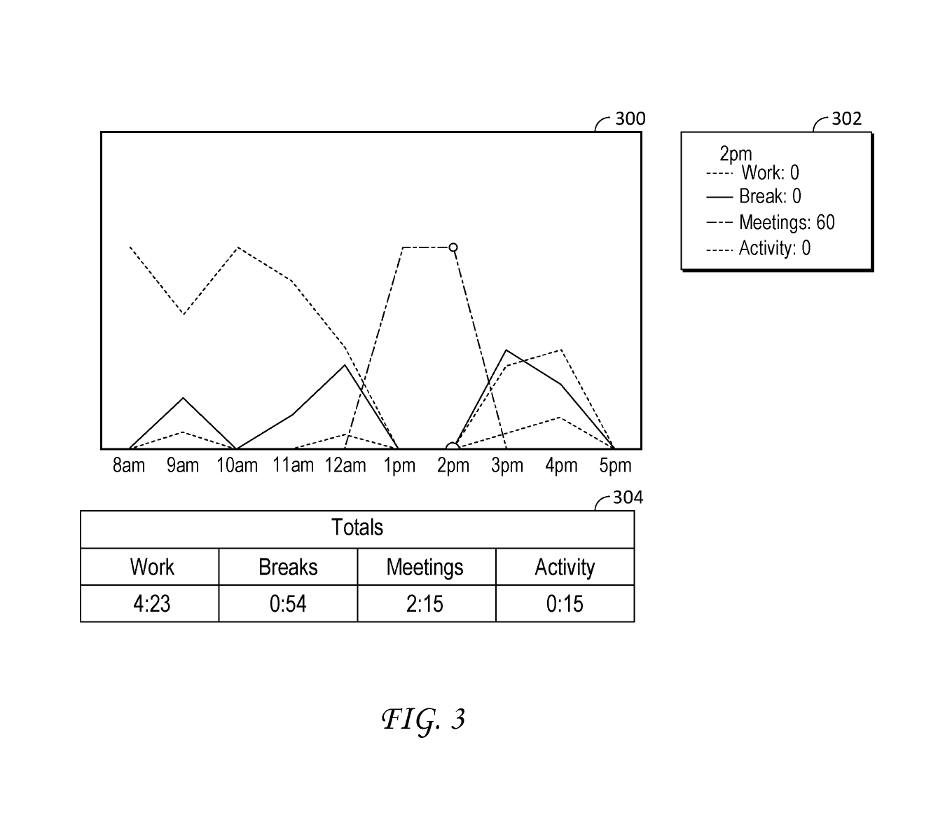

FIG. 3 illustrates graphical examples of user data that can be tracked over the course of a work day. In particular, FIG. 3 illustrates a graph 300 that illustrates a frequency/intensity for various tasks or behavior with respect to time. Events depicted by graph 300 include work, breaks, meetings, and activities. Information box 302 depicts a snapshot of relative levels of each activity type at a specific time (e.g., 2 PM). Similarly, table 304 depicts time totals for each activity type. For example, table 304 indicates that the associated user spent four hours and 23 minutes working, 54 minutes taking breaks, two hours and 15 minutes in meetings, and was physically active for a total of 15 minutes. It is understood that user data can be displayed in various other tabular or graphical formats, without departing from the scope of the technology.

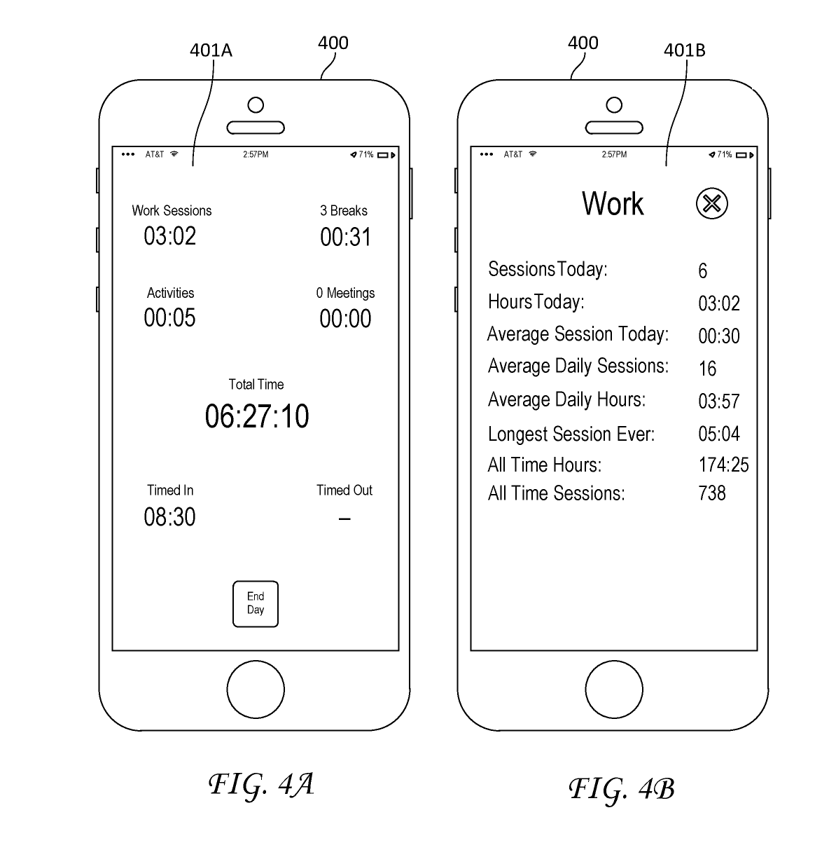

FIG. 4A illustrates an example of a graphical user interface (GUI) that can be used to provide feedback, including user data and various user metrics, to an associated user. In the example of FIG. 4A, a mobile device 400 is used to provide certain types of user data to a user, for example, via GUI 401A. In the provided example, statistics for various activities that occur throughout a work day are displayed, for example, “work sessions” indicates a total time spent working, e.g., at a desk or on the user's workstation/office computer. A “breaks” category is also provided which displays a total time that the user took breaks or periods of rest from work. The “activities” category provides an indication of a total time spent doing non-work/non-break type activities. The “meetings” category indicates the total time spent in meetings. The “total time” category indicates a total duration of time at work. Lastly, the “timed in” and “timed out” categories indicate a time of day that the user arrived to (checked into) and departed (checked out of) work, respectively.

FIG. 4B illustrates another example of a GUI 401B that can be used to display various categories of user data. In the example of FIG. 4 B, user data is displayed for a specific behavior/task category, e.g., “work.” In the example of FIG. 4B, the “work” category is further broken into subcategories that include “session today” (e.g., indicating the total number of work sessions throughout the day), “hours today” (e.g., indicating the total duration of time spent working), “average session today” (e.g. indicating an average time spent at each work session), “average daily sessions” (e.g., indicating an average number of work sessions), “average daily hours” (e.g., indicating an average duration of time spent working), “longest session ever” (e.g., indicating a longest work session recorded), “all-time hours” (e.g., indicating a sum of working hours recorded), and “all time sessions” (e.g., indicating a total number of sessions recorded).

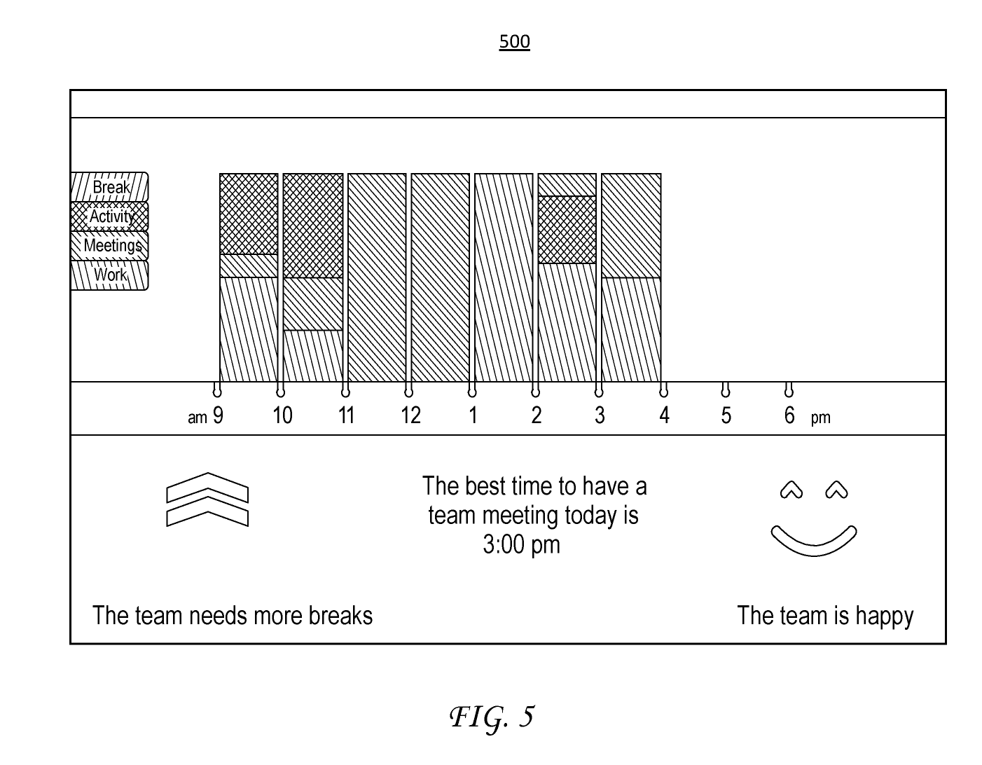

FIG. 5 illustrates an example of a GUI 500 that can be used to provide feedback regarding the performance or well-being of a user team or group of users, according to some aspects. In the example of FIG. 5, certain statistics are provided for a group of users, e.g. a user “team.” For example, GUI 500 provides feedback for different statistical categories including breaks, activities, meetings, and work—which are indicated in relative amounts at various times throughout a work day. GUI 500 also provides an example of targeted communications that can be provided to give an overall wellness status for a team, and/or to make specific recommendations for how to improve team performance or well-being.

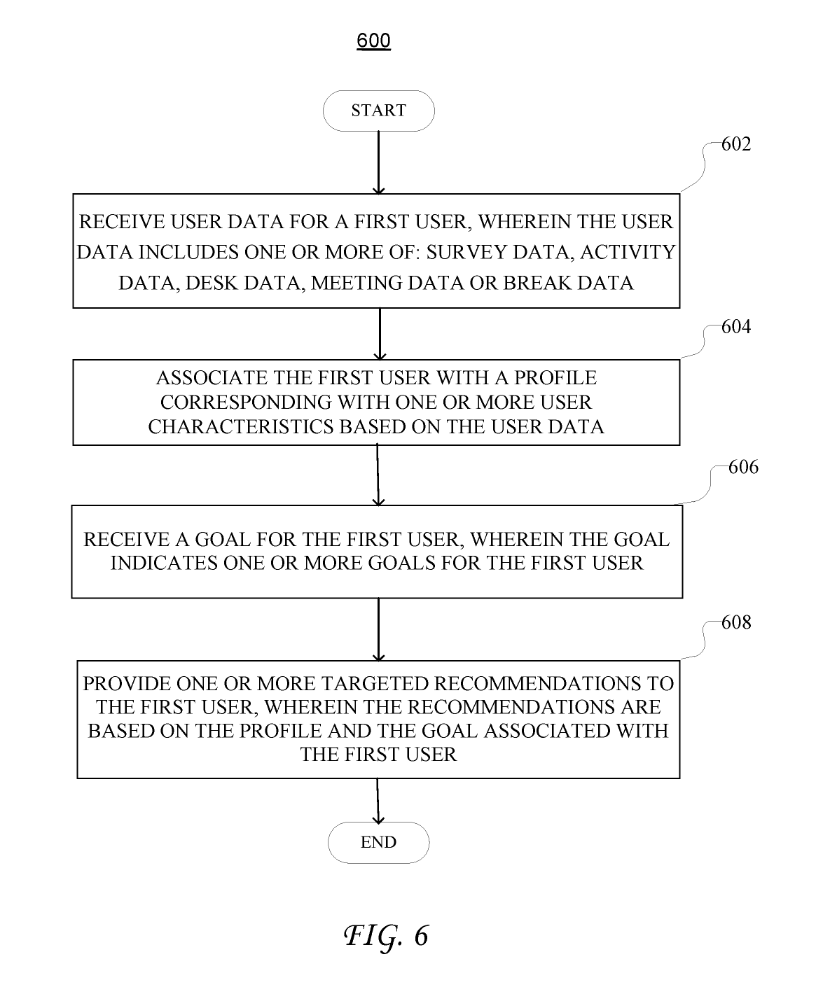

FIG. 6 illustrates steps of an example method 600 that can be used to implement a wellness tracking system. Method 600 begins with step 602 in which data is received (e.g., by a server or wellness tracking system) for a user (e.g., a first user), wherein the user data includes one or more of: survey data, activity data, desk data, meeting data, and/or break data. It is understood that other types of information collected about a user may be included in the received user data, without departing from the scope of the technology. By way of example, other types of information or signals that may be collected could include one or more of the following: a number of emails sent/received, activity on chat or messenger applications, WebEx, face-recognition (for example, detected through laptop camera to track mood via facial expressions), GPS data, and/or data collected by 3^{rd} party health or fitness trackers and applications, etc.

In step 604, the user is associated with a profile corresponding with one or more user characteristics, for example, based on the received user data. The user profile can define a set of default settings or user-specific characteristics that relate to the user. For example, various profile types (e.g., “workaholic”, “active”, “multitasker”, and “manager”, etc.), may be used to provide an initial classification of behavioral characteristics relating to the user. In some aspects, user profile assignment may be performed based on the user's inputs/responses to one or more survey questions, for example, that are provided to the user during an initial setup of the user's account on the wellness tracking system.

In step 606, one or more goals can be received by the user, for example, which indicate behavioral and/or self-improvement outcomes that the user wishes to actualize. In some implementations the user can also be given a chance to specify one or more personal goals, for example, that the user wishes to achieve with the aid of the tracking system. It is understood that user goals can vary greatly depending on a variety of factors, including but not limited to: the user, the user's location, work environment, user selected preference, privacy settings, and other factors (e.g., the user's occupation), etc. Examples of user goals can include, but are not limited to, one or more of the following: “more productive” (e.g., longer work sessions, fewer intervals, fewer meetings, fewer breaks, etc.), “more focus” (e.g., more breaks, and/or “less interruptions”, etc.).

In practice, the wellness tracking system can analyze received user data, the user's profile, and/or information regarding one or more of the user's goals to determine what steps or actions should be performed (or avoided by) the user in order to reach one or more of his/her goals. In some implementations, continuous tracking of various types of user data may be used to automatically update the user profile associated with the user, thereby improving the accuracy of user data tracking and analysis.

Subsequently, in step 608, one or more targeted recommendations are provided to the user. User provided recommendations can be based on one or more of: the received/collected user data, the user's profile, and/or the goal associated with the user. As discussed above with respect to FIGS. 4A and B, user provided feedback (including targeted recommendations), can include a subset or summary of the collected user data. In other aspects, targeted recommendations which include tips or advice can be provided to the user, for example, to help the user to achieve one or more of his/her goals.

As discussed above, data can be collected for multiple users, such as for each of a number of users in the user group or team. For example a user group may consist of the employees in an office or work environment. Just as user data may be collected and analyzed for a single user, user data for multiple users (e.g., a user group), can be collected and used to make determinations regarding the health or well-being of the user group.

In practice, user data collected for an entire user group may be used to provide suggestions regarding behaviors or actions that may serve the group as a whole. Further to the example provided with respect to FIG. 5, targeted notifications may be generated, for example, to recommend that the group or team “need more breaks”, or to suggest a best time during the week/day for a meeting.

By assessing the mental well-being or wellness of an entire user group (e.g., a group of office employees), a manager or other team leader (such as a human resources director), can be better equipped to make actionable determinations about how to best manage the office environment.

In some implementations, gamification features may be introduced into the feedback or notifications that are provided, for example, to a group of users or user team. By way of example, point totals corresponding with a team's success in reaching its goals, may be provided. Scoring or point totals can also be used to provide a composite quantified representation of the group's overall well-being (e.g., mental health). In some aspects, gamification features can encourage improvements to individual behavior by encouraging competition between individual users and user teams.

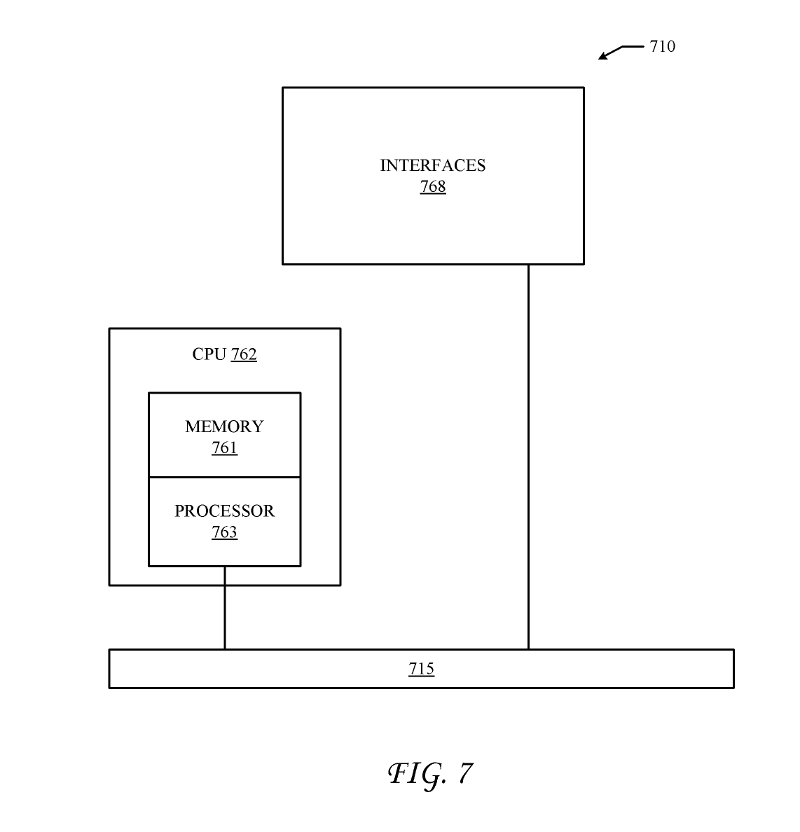

FIG. 7 illustrates an example network device 710 (e.g., a router) according to some embodiments. Network device 710 includes a master central processing unit (CPU) 762, interfaces 768, and a bus 715 (e.g., a PCI bus). When acting under the control of appropriate software or firmware, the CPU 762 is responsible for executing packet management, error detection, and/or routing functions. The CPU 762 preferably accomplishes all these functions under the control of software including an operating system and any appropriate applications software. CPU 762 can include one or more processors 763 such as a processor from the Motorola family of microprocessors or the MIPS (Microprocessor without Interlocked Pipeline Stages) family of microprocessors. In an alternative embodiment, processor 763 is specially designed hardware for controlling the operations of router 710. In a specific embodiment, a memory 761 (such as non-volatile RAM and/or ROM) also forms part of CPU 762. However, there are many different ways in which memory could be coupled to the system.

The interfaces 768 are typically provided as interface cards (sometimes referred to as “line cards”). Generally, they control the sending and receiving of data packets over the network and sometimes support other peripherals used with the router 710. Among the interfaces that can be provided are Ethernet interfaces, frame relay interfaces, cable interfaces, Digital Subscriber Line (DSL) interfaces, token ring interfaces, and the like. In addition, various very high-speed interfaces can be provided such as fast token ring interfaces, wireless interfaces, Ethernet interfaces, Gigabit Ethernet interfaces, ATM interfaces, High Speed-Serial Interfaces (HSSI), Packet-Over-SONET (POS) interfaces, Fiber Distributed Data Interface (FDDI), and the like.

Generally, these interfaces can include ports appropriate for communication with the appropriate media. In some cases, they can also include an independent processor and, in some instances, volatile RAM. The independent processors can control such communications intensive tasks as packet switching, media control and management. By providing separate processors for the communications intensive tasks, these interfaces allow the master microprocessor 762 to efficiently perform routing computations, network diagnostics, security functions, etc.

Although the system shown in FIG. 7 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it can employ one or more memories or memory modules (including memory 761) configured to store program instructions for the general-purpose network operations and mechanisms for roaming, route optimization and routing functions described herein. The program instructions can control the operation of an operating system and/or one or more applications, for example. The memory or memories can also be configured to store tables such as mobility binding, registration, and association tables, etc.

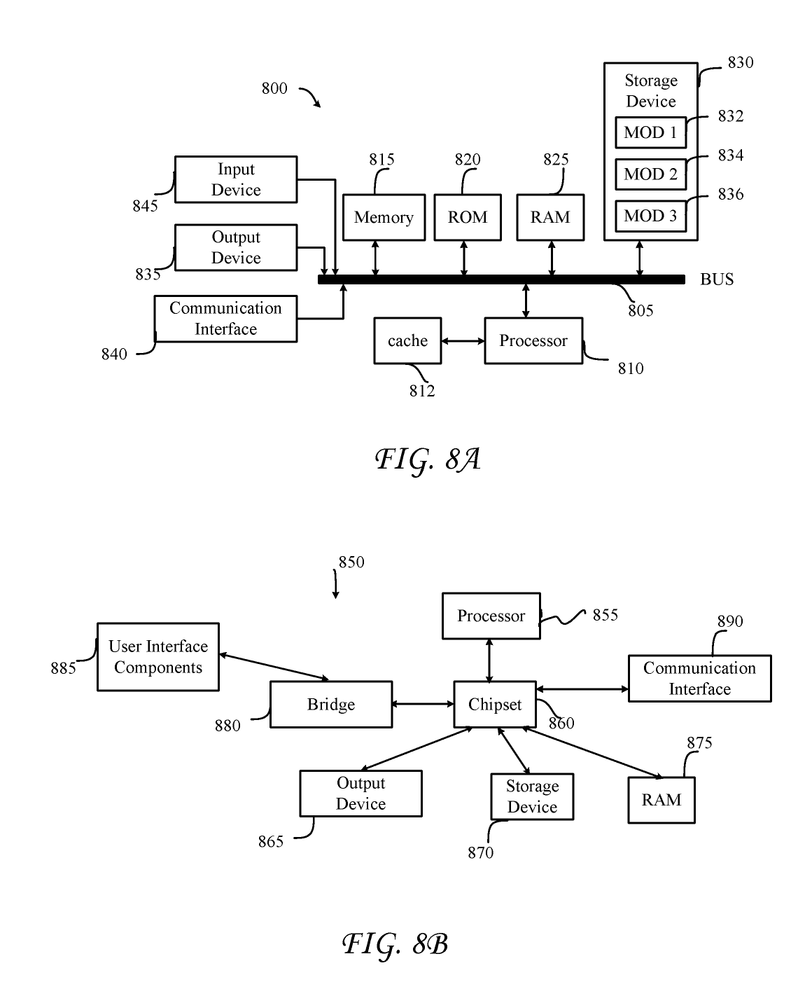

FIG. 8A and FIG. 8B illustrate example system embodiments. The more appropriate embodiment will be apparent to those of skill in the art when practicing the present technology. Persons of ordinary skill in the art will also readily appreciate that other system embodiments are possible.

FIG. 8A illustrates a system bus computing system architecture 800 wherein the components of the system are in electrical communication with each other using a bus 805. System 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 can be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor can be symmetric or asymmetric.

To enable user interaction with the computing system 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing system 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates an example computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output device 865, such as a display, and can read and write information to storage device 870, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that example systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software. In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment”, “variation”, “aspect”, “example”, “configuration”, “implementation”, “case”, and any other terms which may connote an embodiment, as used herein to describe specific features or configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

Moreover, claim language reciting “at least one of” a set indicates that one member of the set or multiple members of the set satisfy the claim. For example, claim language reciting “at least one of A, B, and C” or “at least one of A, B, or C” means A alone, B alone, C alone, A and B together, A and C together, B and C together, or A, B and C together.

What is claimed is:

1. A method comprising:
receiving first user data for a first user, wherein the first user data comprises one or more of: survey data, activity data, desk data, meeting data or break data;
associating the first user with a first profile, wherein the first profile corresponds with one or more user characteristics based on the first user data;
receiving a first goal for the first user, wherein the first goal indicates one or more behavioral goals for the first user; and
providing one or more targeted recommendations to the first user, wherein the one or more targeted recommendations are based on the first profile and the first goal associated with the first user.

2. The method of claim 1, wherein providing the one or more targeted recommendations further comprises:
analyzing the first user data using a machine learning model to generate the one or more targeted recommendations.

3. The method of claim 1, further comprising:
receiving second user data for a second user, wherein the second user data comprises one or more of: survey data, activity data, desk data, meeting data, or break data;
associating the second user with a second profile, wherein the first profile corresponds with one or more user characteristics based on the second user data;
receiving a second goal for the second user, wherein the second goal indicates one or more behavioral goals for the second user; and
providing one or more targeted recommendations to the second user, wherein the one or more targeted recommendations are based on the second profile and the second goal associated with the second user.

4. The method of claim 3, further comprising:
associating the first user and the second user with a user team; and
generating one or more targeted recommendations for the user team, wherein the targeted recommendations are based on user data for each user associated with the user team.

5. The method of claim 1, wherein associating the first user with the first profile further comprises:
providing one or more survey questions to the first user via an electronic device associated with the first user;
receiving at least a subset of the survey data via the electronic device; and
matching the first user with the first profile based on the subset of the survey data.

6. The method of claim 1, wherein the first goal for the first user provides a selection of one or more goal categories including: improve productivity, improve focus, reduce stress, or increase fun.

7. The method of claim 1, wherein providing the one or more targeted recommendations to the first user further comprises:
selecting a communication channel for communicating with the first user based on one or more indicated user preferences; and
transmitting the one or more targeted recommendations via the communication channel.

8. A wellness tracking system comprising:
at least one processor; and
a memory device storing instructions that, when executed by the at least one processor, cause the wellness tracking system to:
receiving first user data for a first user, wherein the first user data comprises one or more of: survey data, activity data, desk data, meeting data or break data;
associating the first user with a first profile, wherein the first profile corresponds with one or more user characteristics based on the first user data;
receiving a first goal for the first user, wherein the first goal indicates one or more behavioral goals for the first user; and
providing one or more targeted recommendations to the first user, wherein the one or more targeted recommendations are based on the first profile and the first goal associated with the first user.

9. The wellness tracking system of claim 8, further comprising:
a machine learning model, wherein the machine learning model is configured to receive the first user data; and
analyze the first user data to generate the one or more targeted recommendations.

10. The wellness tracking system of claim 8, further comprising:
receiving second user data for a second user, wherein the second user data comprises one or more of: survey data, activity data, desk data, meeting data, or break data;
associating the second user with a second profile, wherein the first profile corresponds with one or more user characteristics based on the second user data;
receiving a second goal for the second user, wherein the second goal indicates one or more behavioral goals for the second user; and
providing one or more targeted recommendations to the second user, wherein the one or more targeted recommendations are based on the second profile and the second goal associated with the second user.

11. The wellness tracking system of claim 10, further comprising:
associating the first user and the second user with a user team; and
generating one or more targeted recommendations for the user team, wherein the targeted recommendations are based on user data for each user associated with the user team.

12. The wellness tracking system of claim 10, wherein associating the first user with the first profile further comprises:
providing one or more survey questions to the first user via an electronic device associated with the first user;
receiving at least a subset of the survey data via the electronic device; and
matching the first user with the first profile based on the subset of the survey data.

13. The wellness tracking system of claim 8, wherein the first goal for the first user provides a selection of one or more goal categories including: improve productivity, improve focus, reduce stress, or increase fun.

14. The wellness tracking system of claim 8, wherein providing the one or more targeted recommendations to the first user further comprises:
selecting a communication channel for communicating with the first user based on one or more indicated user preferences; and
transmitting the one or more targeted recommendations via the communication channel.

15. A non-transitory computer-readable storage medium comprising instructions stored therein, which when executed by one or more processors, cause the processors to perform operations comprising:
receiving first user data for a first user, wherein the first user data comprises one or more of: survey data, activity data, desk data, meeting data or break data;
associating the first user with a first profile, wherein the first profile corresponds with one or more user characteristics based on the first user data;
receiving a first goal for the first user, wherein the first goal indicates one or more behavioral goals for the first user; and
providing one or more targeted recommendations to the first user, wherein the one or more targeted recommendations are based on the first profile and the first goal associated with the first user.

16. The non-transitory computer-readable storage medium of claim 15, wherein providing the one or more targeted recommendations further comprises:
analyzing the first user data using a machine learning model to generate the one or more targeted recommendations.

17. The non-transitory computer-readable storage medium claim 15, further comprising:
receiving second user data for a second user, wherein the second user data comprises one or more of: survey data, activity data, desk data, meeting data, or break data;
associating the second user with a second profile, wherein the first profile corresponds with one or more user characteristics based on the second user data;
receiving a second goal for the second user, wherein the second goal indicates one or more behavioral goals for the second user; and
providing one or more targeted recommendations to the second user, wherein the one or more targeted recommendations are based on the second profile and the second goal associated with the second user.

18. The non-transitory computer-readable storage medium of claim 17, further comprising:
associating the first user and the second user with a user team; and
generating one or more targeted recommendations for the user team, wherein the targeted recommendations for the user team are based on user data for each user associated with the user team.

19. The non-transitory computer-readable storage medium of claim 15, wherein associating the first user with the first profile further comprises:
providing one or more survey questions to the first user via an electronic device associated with the first user;
receiving at least a subset of the survey data via the electronic device; and
matching the first user with the first profile based on the subset of the survey data.

20. The non-transitory computer-readable storage medium of claim 15, wherein the first goal for the first user provides a selection of one or more goal categories including: improve productivity, improve focus, reduce stress, or increase fun.
